(19) United States
(12) Patent Application Publication
(10) Pub. No.: US 2026/0075246 A1
(43) Pub. Date: Mar. 12, 2026

(54) Video Encoding Apparatus, Three-Dimensional Broadcast Transmission Apparatus and Method Including the Same

(71) Applicants: Electronics and Telecommunications Research Institute, Daejeon (KR); KOOKMIN UNIVERSITY INDUSTRY ACADEMY COOPERATION FOUNDATION, Seoul (KR); KAI MEDIA Co., Daejeon (KR)

(72) Inventors: Sung Hoon KIM, Daejeon (KR); Seong Won JUNG, Daejeon (KR); Dong Wook KANG, Seoul (KR); Jin Suk KWAK, Daejeon (KR); Min Suk LEE, Daejeon (KR); Jun Geun JEON, Daejeon (KR)

(73) Assignees: Electronics and Telecommunications Research Institute, Daejeon (KR); KOOKMIN UNIVERSITY INDUSTRY ACADEMY COOPERATION FOUNDATION, Seoul (KR); KAI MEDIA Co., Daejeon (KR)

(21) Appl. No.: 19/299,571

(22) Filed: Aug. 14, 2025

(30) Foreign Application Priority Data
Aug. 14, 2024 (KR) 10-2024-0109399
Aug. 14, 2024 (KR) 10-2024-0109400
Aug. 12, 2025 (KR) 10-2025-0111796
Aug. 12, 2025 (KR) 10-2025-0111797

(51) Int. Cl. H04N 19/597; H04N 19/132; H04N 19/159; H04N 19/187; H04N 19/33

(52) U.S. Cl. CPC H04N 19/597; H04N 19/132; H04N 19/159; H04N 19/187; H04N 19/33

(57) ABSTRACT

The present invention relates to a video encoding apparatus, a three-dimensional (3D) broadcast transmission apparatus including the same, and a 3D broadcast transmission method, and the video encoding apparatus includes a memory configured to store a program for encoding a 3D video and a processor configured to execute the program stored in the memory, wherein the processor encodes a downsampled low-resolution additional view to generate a base layer bitstream, upscales the encoded low-resolution additional view, and secondarily encodes a residual signal between a reference view and the upscaled additional view to generate an enhancement layer bitstream.

### CROSS-REFERENCE TO RELATED APPLICATION

This application claims priority to and the benefit of Korean Patent Application No. 10-2024-0109399, filed Aug. 14, 2024, Korean Patent Application No. 10-2024-0109400, filed Aug. 14, 2024, Korean Patent Application No. 10-2025-0111796, filed Aug. 12, 2025, and Korean Patent Application No. 10-2025-0111797, filed Aug. 12, 2025, the disclosure of which is incorporated herein by reference in its entirety.

### BACKGROUND

### Field of the Invention

The present invention relates to a video encoding apparatus for encoding a stereoscopic three-dimensional (s3D) video, a 3D broadcast transmission apparatus including the same, and a 3D broadcast transmission method.

### Discussion of Related Art

Demand for high-resolution content, such as 4K ultra high-definition (UHD), has been increasing recently, and immersive content, such as stereoscopic three-dimensional (s3D) content, has gained significant attention, leading to a significant increase in video capacity.

In order to efficiently store and transmit large amounts of data, such as immersive content, demand for codecs with high compression performance is increasing.

For s3D videos, left-and right-eye videos (left/right views) should be encoded separately, and thus the s3D videos require approximately twice the encoding complexity and bandwidth requirements of 2D videos. Accordingly, in conventional 3D video encoding methods, prediction-based techniques and common region extraction techniques are utilized to improve encoding efficiency, but there is still a need for improvement in terms of computational volume and complexity. In particular, demand for lightweight 3D encoding technologies that can be applied even in low-latency (real-time) and low-power environments is increasing.

### SUMMARY OF THE INVENTION

The present invention is directed to providing a video encoding apparatus capable of effectively encoding a stereoscopic three-dimensional (3D) video to provide a high-definition broadcasting service, a 3D broadcast transmission apparatus including the same, and a 3D broadcast transmission method.

According to an aspect of the present invention, there is provided a video encoding apparatus which includes a memory configured to store a program for encoding a 3D video and a processor configured to execute the program stored in the memory, wherein the processor encodes a downsampled low-resolution additional view to generate a base layer bitstream, upscales the encoded low-resolution additional view, and secondarily encodes a residual signal between a reference view and the upscaled additional view to generate an enhancement layer bitstream.

In the present invention, the processor may include a downsampling converter that downsamples the additional view into a low-resolution additional view, a first encoder that encodes the downsampled low-resolution additional view according to a preset encoding method to generate the base layer bitstream, and a second encoder that upscales the low-resolution additional view encoded by the first encoder and encodes the residual signal between the reference view and the upscaled additional view to generate the enhancement layer bitstream.

In the present invention, the second encoder may encode the residual signal using a Low Complexity Enhancement Video Codec (LCEVC) method.

In the present invention, the first encoder may encode the low-resolution additional view using at least one of Advanced Video Coding (AVC), High Efficiency Video Coding (HEVC), and Versatile Video Coding (VVC) methods.

In the present invention, the first encoder may perform encoding using a multi-layer VVC method, and the first encoder may encode the downsampled low-resolution additional view to generate the base layer bitstream and a restored additional view, re-sample the restored additional view, perform intra-screen or inter-screen prediction of the re-sampled additional view, then generate the residual signal with respect to the reference view, encode the residual signal to generate the restored reference view, and input the restored reference view to the second encoder.

In the present invention, the first encoder may perform encoding using a multi-layer VVC method, and the first encoder may encode the downsampled low-resolution additional view to generate the base layer bitstream and a restored additional view, re-sample the restored additional view, perform disparity refinement on the re-sampled additional view on the basis of a depth map, perform intra-screen or inter-screen prediction of the disparity-refined additional view, then generate the residual signal with respect to the reference view, encode the residual signal to generate the restored reference view, and input the restored reference view to the second encoder.

In the present invention, the second encoder may upscale the restored reference view, perform disparity refinement on the upscaled reference view on the basis of the depth map, and encode the residual signal between the reference view and the disparity-refined additional view to generate the enhancement layer bitstream.

In the present invention, the first encoder may perform encoding using a stereoscopic 3D VVC method, and the first encoder may encode the downsampled low-resolution additional view using a VVC method to generate the base layer bitstream, encode the reference view using a VVC method to generate the restored reference view, and input the restored reference view to the second encoder.

In the present invention, the second encoder may upscale the restored reference view, perform disparity refinement on the upscaled reference view on the basis of the depth map, and encode the residual signal between the reference view and the disparity-refined additional view to generate the enhancement layer bitstream.

The present invention may further include a video enhancement information (VEI) encoder configured to receive at least one of the additional view, the reference view restored by the second encoder, and the additional view restored by the first encoder and generate additional information for generating a high-resolution additional view with improved video quality.

In the present invention, the processor may receive the reference view and the low-resolution additional view and generate additional information for generating a high-resolution additional view with improved video quality.

According to another aspect of the present invention, there is provided a 3D broadcast transmission apparatus that encodes a reference view and an additional view that constitute a 3D video to provide a service, which includes a first encoder configured to encode a downsampled low-resolution additional view to generate a base layer bitstream, a second encoder configured to upscale the low-resolution additional view encoded by the first encoder and encode a residual signal between the reference view and the upscaled additional view to generate an enhancement layer bitstream, a multiplexer configured to multiplex the base layer bitstream and the enhancement layer bitstream, and a transmitter configured to transmit the multiplexed streams to a reception apparatus.

In the present invention, the first encoder may perform encoding using at least one of AVC, HEVC, VVC, multi-layer VVC, and stereoscopic 3D VVC methods.

In the present invention, when the first encoder performs encoding using the multi-layer VVC method, the first encoder may encode the downsampled resolution additional view to generate the base layer bitstream and a restored additional view, re-sample the restored additional view, perform disparity refinement on the re-sampled additional view on the basis of a depth map, perform intra-screen or inter-screen prediction of the disparity-refined additional view, then generate the residual signal with respect to the reference view, encode the residual signal to generate the restored reference view, and input the restored reference view to the second encoder.

In the present invention, when the first encoder performs encoding using the stereoscopic 3D VVC method, the first encoder may encode the downsampled low-resolution additional view using a VVC method to generate the base layer bitstream, encode the reference view using a VVC method to generate the restored reference view, and input the restored reference view to the second encoder.

In the present invention, the second encoder may perform disparity refinement on the upscaled additional view using a pre-stored depth map.

According to still another aspect of the present invention, there is provided a 3D broadcast transmission method which includes encoding, by a processor, a downsampled low-resolution additional view and generating a base layer bitstream, upscaling, by the processor, the encoded low-resolution additional view, encoding a residual signal between a reference view and the upscaled additional view, and generating an enhancement layer bitstream, and transmitting, by the processor, the base layer bitstream and the enhancement layer bitstream.

In the present invention, in the generating of the base layer bitstream, the processor may perform encoding using at least one of AVC, HEVC, and VVC methods.

In the present invention, in the generating of the enhancement layer bitstream, the processor may perform disparity refinement on the upscaled additional view using a pre-stored depth map.

The present invention may further include receiving, by the processor, the reference view and the low-resolution additional view and generating additional information for generating a high-resolution additional view with improved video quality.

Meanwhile, in the video encoding apparatus, the 3D broadcast transmission apparatus including the same, and the 3D broadcast transmission method according to some embodiments of the present invention, disparity refinement on an additional view can be perform by utilizing binocular disparity information, a residual signal between an original reference view and the additional view can be reduced based on the disparity-refined additional view, and thus the encoding performance of 3D LCEVC can be improved, thereby providing higher quality s3D stereoscopic media content.

In the video encoding apparatus, the 3D broadcast transmission apparatus including the same, and the 3D broadcast transmission method according to some embodiments of the present invention, by improving the encoding performance of 3D LCEVC, high-quality streaming services and real-time broadcasting services can be provided.

In the video encoding apparatus, the 3D broadcast transmission apparatus including the same, and the 3D broadcast transmission method according to some embodiments of the present invention, in the case in which encoding is performed using multi-layer VVC, disparity refinement on the reference view can be performed to generate an improved reference view, thereby improving the encoding performance of inter-screen prediction, and the generated improved reference view can be used as input to LCEVC, and thus a reference view with further improved video quality can be generated.

In the video encoding apparatus, the 3D broadcast transmission apparatus including, and the 3D broadcast transmission method the same according to some embodiments of the present invention, high-resolution additional view with improved picture quality can be generated by combining VEI with 3D LCEVC, and thus high-quality 3D content can be synthesized based on the generated high-resolution additional view.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a three-dimensional (3D) broadcast transmission apparatus for providing a 3D broadcasting service according to an embodiment of the present invention;

FIG. 2 is a diagram for describing a video encoding apparatus according to an embodiment of the present invention;

FIG. 3 is a schematic diagram illustrating a configuration of a video encoding apparatus according to another embodiment of the present invention;

FIG. 4 is a block diagram illustrating a 3D broadcast transmission apparatus for providing a 3D broadcasting service according to another embodiment of the present invention;

FIGS. 5 and 6 are diagrams for describing a third encoder illustrated in FIG. 4;

FIG. 7 is an exemplary diagram illustrating an example of data transmission of a 3D broadcast transmission apparatus for providing a 3D broadcasting service according to an embodiment of the present invention;

FIG. 8 is a block diagram illustrating a 3D broadcast transmission apparatus for providing a 3D broadcasting service according to still another embodiment of the present invention;

FIG. 9 is a diagram for describing a 5-1 encoder and 5-2 encoder described in FIG. 8;

FIG. 10 is a block diagram illustrating a 3D broadcast transmission apparatus for providing a 3D broadcasting service according to yet another embodiment of the present invention;

FIG. 11 is a flowchart for describing a 3D broadcast transmission method according to an embodiment of the present invention;

FIG. 12 is a flowchart for describing a 3D broadcast transmission method according to another embodiment of the present invention;

FIG. 13 is a flowchart for describing a 3D broadcast transmission method according to still another embodiment of the present invention;

FIG. 14 is a flowchart for describing a 3D broadcast transmission method according to yet another embodiment of the present invention; and

FIG. 15 is a block diagram illustrating an apparatus according to an embodiment of the present invention.

### DETAILED DESCRIPTION OF EXEMPLARY EMBODIMENTS

Hereinafter, examples of a video encoding apparatus, a three-dimensional (3D) broadcast transmission apparatus including the same, and a 3D broadcast transmission method according to embodiments of the present invention will be described with reference to the accompanying drawings. In this process, thicknesses of lines, sizes of components, and the like illustrated in the drawings may be exaggerated for clarity and convenience of description. Further, some terms which will be described below are defined in consideration of functions in the present invention and meanings may vary depending on, for example, a user or operator's intentions or customs. Therefore, the meanings of these terms should be interpreted based on the scope throughout this specification.

The technology proposed in the present invention is Low Complexity Enhancement Video Codec (LCEVC), which is a codec capable of effectively compressing stereoscopic (s3D) content, and this technology has an advantage of lower encoding complexity than the conventional codec such as scalable high efficiency video coding (SHVC) or multi-layer Versatile Video Coding (VVC), but has a disadvantage of lower encoding performance.

3D LCEVC has a feature of upsampling a restored video of a base codec to generate a residual signal through a difference from an original video. In particular, 3D LCEVC has an advantage of lower encoding complexity because it generates a residual in a simpler way than the conventional standard codecs.

According to the present invention, disparity refinement is performed on an additional view by utilizing binocular disparity information, and a residual signal between an original reference view and the additional view is reduced based on the disparity refinement, thereby enabling encoding of high-performance 3D LCEVC.

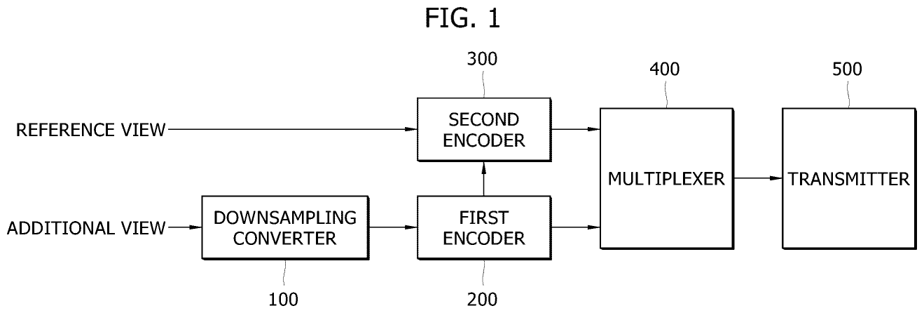

FIG. 1 is a block diagram illustrating a 3D broadcast transmission apparatus for providing a 3D broadcasting service according to an embodiment of the present invention.

Referring to FIG. 1, the 3D broadcast transmission apparatus for providing a 3D broadcasting service may include a downsampling converter 100, a first encoder 200, a second encoder 300, a multiplexer 400, and a transmitter 500.

The downsampling converter 100 may downsample an additional view of a stereoscopic video into a low-resolution additional view. Here, the additional view may be a view additionally applied to a reference view to generate a stereoscopic video in a 3D television (3DTV) service. The reference view may be a view that becomes a reference, among two videos that constitute the stereoscopic video in the 3DTV service. Therefore, the reference view may be one of left and right views, and the other that is not the reference view may be the additional view. The left view may be a view provided to the left eye and the right view may be a view provided to the right eye. The left and right views may be ultra-high-definition (UHD) resolution views, and the additional view may be downsampled into a HD resolution view.

The downsampling converter 100 may downsample either the left or right view into a low-resolution view according to a stereoscopic video capture environment, a network environment, etc.

The first encoder 200 may encode the low-resolution additional view downsampled by the downsampling converter 100 using a preset encoding method. Here, the preset encoding method may include Advanced Video Coding (AVC), High Efficiency Video Coding (HEVC), VVC, multi-layer VVC, s3D VVC, etc., but the present invention is not limited thereto. By applying VVC, the first encoder 200 may encode videos more effectively within a limited bandwidth.

Further, the first encoder 200 may perform encoding on the low-resolution additional view downsampled by the downsampling converter 100 using multi-layer VVC.

Further, the first encoder 200 may perform encoding on the low-resolution additional view downsampled by the downsampling converter 100 using s3D VVC.

The second encoder 300 may generate an enhancement layer bitstream (referred to as an enhancement bitstream) on the basis of the reference view and the low-resolution additional view encoded by the first encoder 200. In this case, the second encoder 300 may upscale the low-resolution additional view encoded by the first encoder 200, perform disparity refinement on the upscaled additional view on the basis of a depth map, and encode a residual signal between the reference view and the disparity-refined additional view to generate the enhancement layer bitstream.

Alternatively, the second encoder 300 may restore the low-resolution additional view from the first encoder 200 to be an original resolution additional view using an upscaler, calculate a difference (residual) between the restored additional view and the reference view, and sequentially perform temporal prediction, transform, quantization, and entropy encoding on the calculated residual to generate an enhancement layer bitstream composed of an L-1 coefficient layer and a temporal layer.

In this way, by utilizing a modified hierarchical encoding method, a 3DTV broadcast reception apparatus may acquire a reference view using an enhancement layer bitstream even when a 3DTV broadcast transmission apparatus does not directly transmit the reference view.

The multiplexer 400 may multiplex a base layer bitstream (referred to as a base bitstream) generated by the first encoder 200 and the enhancement layer bitstream generated by the second encoder 300. That is, the multiplexer 400 may combine the base layer bitstream and the enhancement layer bitstream into a single transport stream. Specifically, the multiplexer 400 may merge the base layer bitstream and the enhancement layer bitstream in Common Media Application Format (CMAF) segment units and insert a track identifier track_ID and profile information that correspond to each bitstream into a media presentation description (MPD) to generate metadata so that a receiving decoder can accurately separate and decode the two streams. In this case, the multiplexer 400 may also multiplex header information such as supplemental enhancement information (SEI) messages, video parameter (VPS)/set sequence parameter set (SPS) messages, etc. That is, the multiplexer 400 may insert the track identifier track_ID, a VPS/SPS header, an SEI message, etc. of each stream together to generate metadata so that the receiving decoder can accurately separate and synchronize two layers.

The multiplexed streams allow the receiving decoder to separate and decode each stream and finally reconstruct a high-quality s3D video.

The transmitter 500 may transmit the streams multiplexed by the multiplexer 400 to a reception apparatus. In this case, the transmitter 500 may encapsulate the streams multiplexed by the multiplexer 400 in orthogonal frequency-division multiplexing (OFDM) symbols and then transmit a radio frequency (RF) signal through a transmission antenna.

The transmitter 500 may convert the base layer bitstream and the enhancement layer bitstream into at least one transport stream and transmit the at least one converted transport stream. Here, the transport stream may be called a physical layer pipe (PLP) stream, or a different term may be used as the transport stream according to the type of network through which the stream is transmitted. For example, when the base layer bitstream and the enhancement layer bitstream are each converted into different transport streams, the transport stream corresponding to the base layer bitstream may be transmitted through a mobile TV channel of a mobile network and the transport stream corresponding to the enhancement layer bitstream may be transmitted through a fixed TV channel of a broadcast network. Conversely, when the base layer bitstream and the enhancement layer bitstream are converted into a single transport stream, the transport stream may be transmitted through the same network. The transmitter 500 may modulate the at least one converted transport stream using a predetermined modulation scheme and transmit the modulated transport stream. When the base layer bitstream and the enhancement layer bitstream are each converted into different transport streams, the transmitter 500 may modulate the respective transport streams using different modulation schemes. For example, the transport stream corresponding to the base layer bitstream may be modulated using QPSK or 16-QAM that has relatively superior reception performance, and the transport stream corresponding to the enhancement layer bitstream may be modulated using 256-QAM that has high transmission efficiency.

The transmitter 500 may transmit the multiplexed transport streams through wireless or wired broadcast channels. The reception apparatus may decode the streams in an optimized manner according to the present technology, to enable 3D content to play in real time.

The reception apparatus may demultiplex the RF signal to separately restore the base layer bitstream and the enhancement layer bitstream and finally output a high-resolution 3D video to a LCEVC decompressor. That is, the reception apparatus may decode the additional view on the basis of the base codec and then decode the reference view using the restored additional view and the enhancement layer.

The 3D broadcast transmission apparatus of the present invention may provide an effective structure capable of transmitting a high-quality 3D video in real time while efficiently utilizing transmission bandwidths by combining the conventional video compression technology (e.g., base codec) and a low complexity enhancement coding technology (e.g., LCEVC).

Meanwhile, in the present embodiment, the downsampling converter 100, the first encoder 200, the second encoder 300, and the multiplexer 400 may be implemented by one or more computational devices. Here, the computational devices may include any type of device capable of processing data, such as a processor. Here, “processor” may mean a data processing device built into hardware that has a physically structured circuit to perform a function expressed by, for example, code or instructions included in a program. As an example of the data processing device built into hardware, processing devices such as a microprocessor, a central processing unit (CPU), a processor core, a multiprocessor, an application-specific integrated circuit (ASIC), and a field programmable gate array (FPGA) may be used, but the scope of the present invention is not limited thereto.

Hereinafter, for convenience of description, the reference view will be described as being referred to as a left view, the additional view will be described as being referred to as a right view, and the downsampling converter 100, the first encoder 200, and the second encoder 300 will be described as being referred to as a video encoding apparatus.

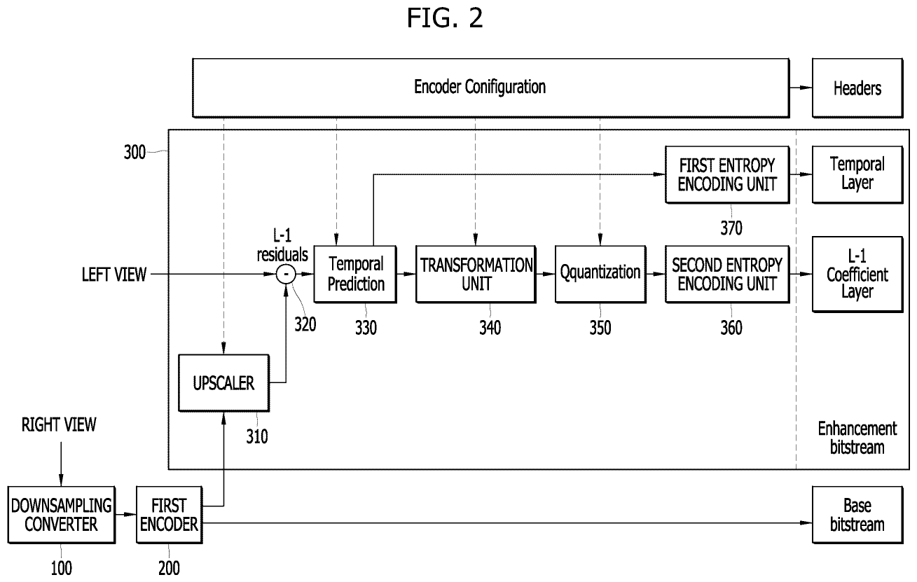

FIG. 2 is a diagram for describing a video encoding apparatus according to an embodiment of the present invention.

Referring to FIG. 2, the video encoding apparatus according to an embodiment of the present invention may include a downsampling converter 100, a first encoder 200, and a second encoder 300.

The downsampling converter 100 may downsample a right view of a stereoscopic video into a low-resolution right view.

The first encoder 200 may encode the low-resolution right view downsampled by the downsampling converter 100 using a preset encoding method. Here, the preset encoding method may include AVC, HEVC, VVC, etc., but the present invention is not limited thereto, and thus other encoding methods may be used. The first encoder 200 may encode a video more effectively within a limited bandwidth by applying VVC.

The second encoder 300 may upscale the low-resolution right view firstly encoded by the first encoder 200 and secondarily encode a residual signal between a reference view and the upscaled right view to generate an enhancement layer bitstream.

The second encoder 300 may include an upscaler 310, an L-1 residual subtractor 320, a temporal prediction unit 330, a transformation unit 340, a quantization unit 350, a first entropy encoding unit 360, and a second entropy encoding unit 370.

The upscaler 310 may re-interpolate (upsample) the low-resolution right view encoded by the first encoder 200 to be an original resolution right view. That is, the upscaler 310 may upscale the low-resolution right view encoded by the first encoder 200 to generate a right view having the same resolution as an original left view.

The L-1 residual subtractor 320 may calculate a residual, which is a difference component between the right view restored through upscaling and the left view. In this case, the L-1 residual subtractor 320 may compare the restored right view with the left view pixel by pixel to calculate the residual between the two views.

The temporal prediction unit 330 is a component that removes redundant information and increases encoding efficiency by predicting a residual of a current frame on the basis of residual information of a temporally adjacent previous frame before encoding a residual signal generated in an enhancement layer of the current frame.

The temporal prediction unit 330 may predict the residual (difference) signal using a temporal correlation between consecutive frames. That is, the temporal prediction unit 330 may predict the residual of the current frame on the basis of the residual signals of previous frames temporally adjacent to the current frame acquired from the L-1 residual subtractor 320 and calculate a prediction residual error representing a difference between an actual residual signal of the current frame and the predicted residual. The residual of the previous frames may be stored in a temporal buffer (not illustrated) and added to the residual signal of the enhancement layer when the temporal prediction unit 330 is activated. Thereafter, by separately encoding only the prediction residual error, an actual amount of information to be encoded may be reduced, and compression efficiency may be improved. In this way, the temporal prediction unit 330 may calculate a previous frame information-based prediction residual to reduce an amount of information to be encoded.

The transformation unit 340 may transform the prediction residual error calculated by the temporal prediction unit 330 into a frequency domain in units of blocks. The transformation unit 340 may separate the prediction residual error calculated by the temporal prediction unit 330 into transform coefficients in the frequency domain by applying a discrete cosine transform (DCT) or integer transform technique in units of blocks. Specifically, the transformation unit 340 may apply a DCT or an integer transform technique to an input N×N pixel block to separate the prediction residual error into low-frequency and high-frequency components and then output transform coefficients for quantization and entropy encoding. This transformation process may allow encoding efficiency to be maximized by leveraging the energy concentration characteristics of the video.

The quantization unit 350 may perform quantization on the transform coefficients transformed by the transformation unit 340, and thus bitrate control and encoding efficiency may be improved. That is, the quantization unit 350 may perform a function of performing quantization on the transform coefficients to a finite level to meet bitrate and video quality targets to reduce the number of data representation bits and then outputting the quantized coefficient values to increase encoding efficiency.

The quantization unit 350 performs quantization on the transform coefficients according to a quantizer step width. The quantization unit 350 may apply a scaling matrix tailored to the bitrate and video quality targets to the transform coefficients to quantize the corresponding transform coefficients to a finite integer level, and thus the number of data representation bits may be reduced.

The first entropy encoding unit 360 may perform entropy encoding on the quantized transform coefficients to generate a bitstream. In this case, the first entropy encoding unit 360 may generate an L-1 coefficient layer bitstream. That is, the first entropy encoding unit 360 may receive the quantized transform coefficients (low-frequency and high-frequency components) as input and apply a similar context model-based arithmetic encoding technique such as context-adaptive binary arithmetic coding (CABAC) or the like to generate the L-1 coefficient layer bitstream. Accordingly, the first entropy encoding unit 360 may allocate shorter codewords to high-frequency symbols and maximize overall encoding efficiency.

The second entropy encoding unit 370 may perform entropy encoding on the prediction residual error (or predicted time-series residual) generated by the temporal prediction unit 330 to generate a bitstream. In this case, the second entropy encoding unit 370 may generate a time series layer bitstream. That is, the second entropy encoding unit 370 may receive a prediction residual as input and apply an asymmetric numeral systems (ANS) or lightweight half-array-based encoding technique to generate a time-series bitstream. Accordingly, the second entropy encoding unit 370 may generate codewords optimized for prediction error signals and minimize an amount of data.

The enhancement layer bitstream may be formed by integrating the L-1 coefficient layer bitstream generated by the first entropy encoding unit 360 and the time series layer bitstream generated by the second entropy encoding unit 370.

Meanwhile, the second encoder 300 configured as described above has a disadvantage in that encoding performance is low because the second encoder 300 uses the restored right view generated by the first encoder (base encoder) 200 as a reference view.

Accordingly, the present invention proposes a technology in which 3D LCEVC encoding performance can be improved by applying an algorithm that reduces binocular disparity in the process of using the restored right view generated by the first encoder (base encoder) 200 as the reference view.

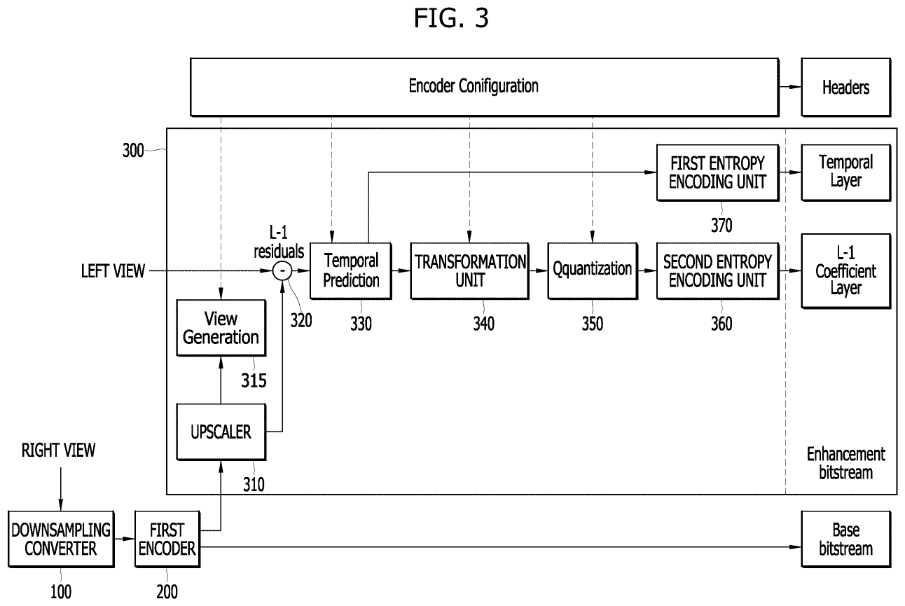

FIG. 3 is a schematic diagram illustrating a configuration of a video encoding apparatus according to another embodiment of the present invention.

Referring to FIG. 3, the video encoding apparatus according to another embodiment of the present invention may include a downsampling converter 100, a first encoder 200, and a second encoder 300.

Since the downsampling converter 100 and the first encoder 200 perform the same operations as the downsampling converter 100 and the first encoder 200 illustrated in FIG. 2, descriptions thereof will be omitted.

The second encoder 300 may upscale the low-resolution right view encoded by the first encoder 200, perform disparity refinement on the upscaled right view on the basis of a depth map, and encode a residual signal between a left view and the disparity-refined right view to generate an enhancement layer bitstream.

The second encoder 300 may include an upscaler 310, a view generation unit 315, an L-1 residual subtractor 320, a temporal prediction unit 330, a transformation unit 340, a quantization unit 350, a first entropy encoding unit 360, and a second entropy encoding unit 370.

The upscaler 310 may re-interpolate (upsample) the low-resolution right view encoded by the first encoder 200 to be an original resolution right view. That is, the upscaler 310 may upscale the low-resolution right view encoded by the first encoder 200 to generate a right view having the same resolution as an original left view. In this case, the upscaler 310 may restore the right view to have the same resolution as an original left view using an interpolation algorithm, such as Bicubic, Lanczos, etc.

The view generation unit 315 may perform disparity refinement on the right view upscaled by the upscaler 310 using the depth map. That is, the view generation unit 315 may utilize disparity or depth information of corresponding left and right viewpoints for each pixel of the right view upscaled by the upscaler 310 to perform view refinement. Here, the depth map may be a map in which depth values corresponding to each pixel of the original left and right views and may be generated and stored in advance.

The view generation unit 315 may perform disparity refinement on the upscaled right view on the basis of the depth map acquired by analyzing a correspondence relationship between the original left and right views. That is, the view generation unit 315 may search the depth map for a depth value corresponding to each pixel of the upscaled right view, calculate a disparity of the pixel on the basis of the searched depth value, and perform disparity refinement on the upscaled right view using the calculated disparity. Specifically, since the depth map includes information about a distance at which each pixel is observed, the view generation unit 315 may calculate a spatial position disparity of each pixel using the depth map. The view generation unit 315 may predict information about a viewpoint observable from the left viewpoint by geometrically warping each pixel of the right view to the left viewpoint coordinate system according to the depth information.

The view generation unit 315 may perform disparity refinement on the upscaled right view by calculating a left viewpoint position corresponding to each pixel of the right view by referencing the depth value of each pixel in the depth map and moving a pixel value of the right view to the calculated left viewpoint position. In this way, the view generation unit 315 may calculate the disparity of the pixel according to the depth map and move the corresponding pixel of the right view in a left-right or front-rear direction.

As a result of the disparity refinement of the view generation unit 315, a predicted video close to the left view may be generated, and the predicted video may then be used as a residual input of the enhancement layer by calculating a difference from the left view. In other words, the view generation unit 315 may generate a virtual view that is geometrically registered with the left view by performing interpolation and depth-based refinement by utilizing the disparity and depth (depth map) information between the right view restored through the upscaler 310 and the left and right viewpoints. In this case, the view generation unit 315 may render corresponding points of each pixel to increase the accuracy of residual calculation and apply a blending technique between views to prevent visual continuity and distortion of the 3D video.

In this way, the view generation unit 315 may refine the disparity between viewpoints to enable more precise prediction and improved encoding and may contribute to improving overall encoding efficiency and video quality.

The L-1 residual subtractor 320 may calculate a difference component (residual) between the left view and the disparity-refined right view. In this case, the L-1 residual subtractor 320 may compare the left view with the disparity-refined right view pixel by pixel to calculate a residual between the two views. The residual component may become a primary encoding target of the enhancement layer.

The L-1 residual subtractor 320 may generate spatial residuals (L-1 residuals) by calculating a difference between the left view and the parallax-refined right view pixel by pixel. The L-1 residual subtractor 320 may generate a difference map by calculating a difference between each pixel value of the disparity-refined right view and the corresponding pixel value of the left view. The difference value (spatial residual) includes detailed structures, texture, edges, etc. that exist only in the left view, and thus the difference value (spatial residual) may serve to supplement spatial details that are not expressed in the low-resolution right view. The spatial residual may define core high-frequency information (i.e., fine spatial information such as edges and texture) that the enhancement layer should restore and may be an essential input signal for reconstructing high-resolution videos close to the original even after compression through subsequent transformation, quantization, and encoding processes.

Since the transformation unit 340, the quantization unit 350, the first entropy encoding unit 360, and the second entropy encoding unit 370 perform the same operations as the transformation unit 340, the quantization unit 350, the first entropy encoding unit 360, and the second entropy encoding unit 370 illustrated in FIG. 2, detailed descriptions thereof will be omitted.

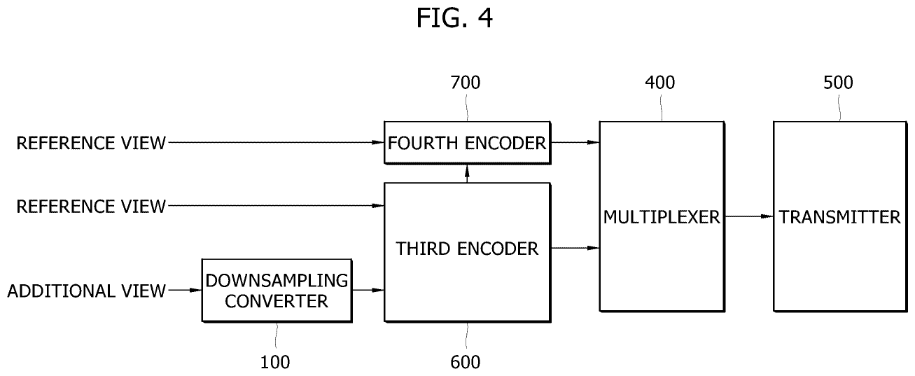

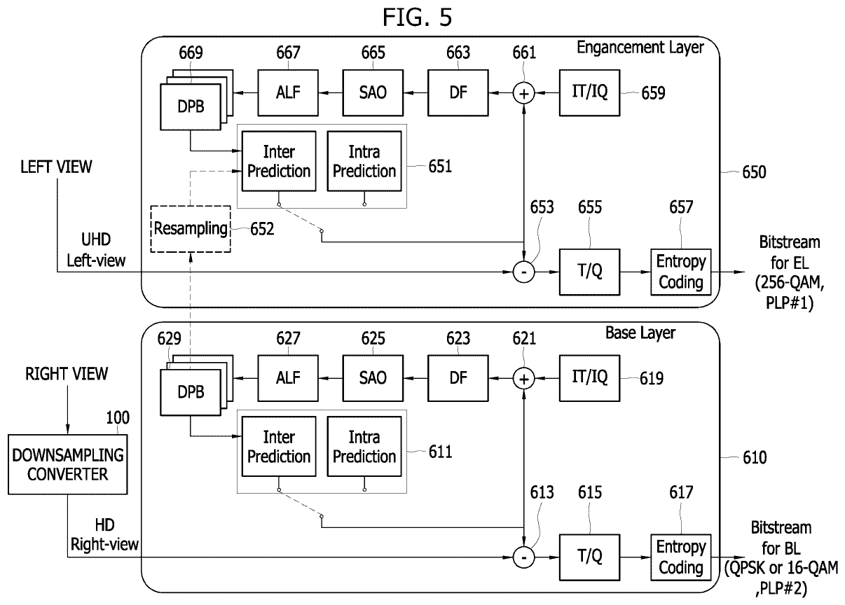

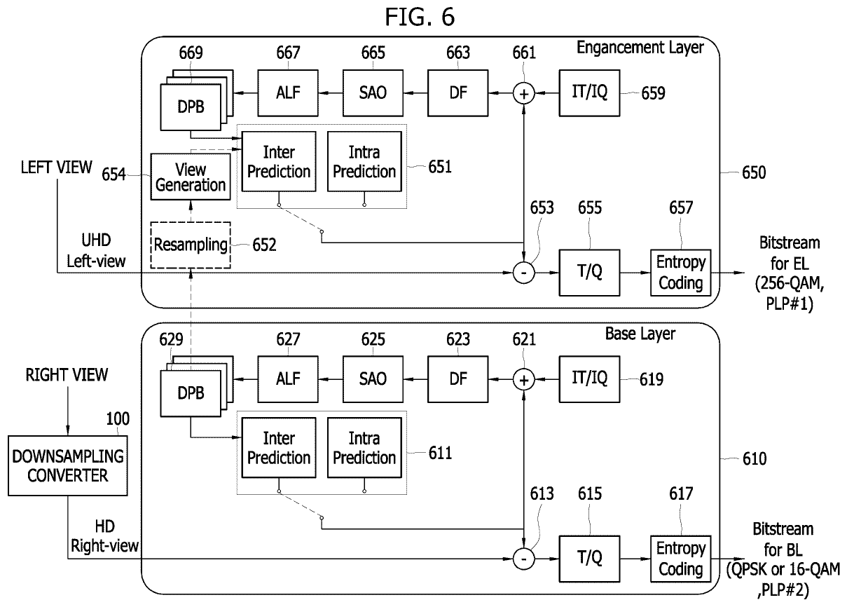

FIG. 4 is a block diagram illustrating a 3D broadcast transmission apparatus for providing a 3D broadcasting service according to another embodiment of the present invention, and FIGS. 5 and 6 are diagrams for describing a third encoder illustrated in FIG. 4.

Referring to FIG. 4, the 3D broadcast transmission apparatus for providing a 3D broadcasting service according to another embodiment of the present invention may include a downsampling converter 100, a third encoder 600, a fourth encoder 700, a multiplexer 400, and a transmitter 500.

The downsampling converter 100 may downsample an additional view of a stereoscopic video into a low-resolution additional view.

The third encoder 600 may encode a left view and the low-resolution right view downsampled by the downsampling converter 100 using a preset encoding method. Here, the preset encoding method may be a multi-layer VVC method. That is, the third encoder 600 may encode the left view and the low-resolution right view downsampled by the downsampling converter 100 using a multi-layer VVC method. In this case, the third encoder 600 may generate a base layer bitstream and an enhancement layer bitstream by performing encoding on the high-resolution left view and the low-resolution right view by dividing the high-resolution left view and the low-resolution right view into a base layer and an enhancement layer, and the enhancement layer bitstream may be used as input to the fourth encoder 700.

A detailed description of the third encoder 600 will be described with reference to FIGS. 5 and 6.

The third encoder 600 may include a 3-1 encoder 610 and a 3-2 encoder 650, as illustrated in FIG. 5.

The 3-1 encoder 610 may encode the downsampled low-resolution right view using a preset encoding method to generate a base layer bitstream. In this case, the 3-1 encoder 610 may encode the downsampled low-resolution right view using multi-layer VVC.

The 3-1 encoder 610 may include an inter/intra prediction unit 611, a residual subtractor 613, a transform/quantization (T/Q) unit 615, an entropy coding unit 617, an inverse transform/inverse quantization (IT/IQ) unit 619, a calculation unit 621, a deblocking filter (DF) unit 623, a sample adaptive offset) (SAO) unit 625, an adaptive loop filter (ALF) unit 627, and a decoded picture buffer (DPB) 619.

The inter/intra prediction unit 611 may generate a predicted video from temporal or inter-layer reference views, and a corresponding predicted block may be used for subsequent residual calculations. The inter/intra prediction unit 611 may generate a predicted block from adjacent blocks within the same frame to remove spatial overlap.

The residual subtractor 613 may calculate a difference between the downsampled low-resolution right view and the predicted video predicted by the inter/intra prediction unit 611 to calculate a prediction error (residual signal).

The T/Q unit 615 may perform frequency conversion (DCT or the like) and quantization processing on the residual signal calculated by the residual subtractor 613 to improve encoding efficiency.

The entropy coding unit 617 may compress the quantized residual signal using CABAC, or the like to generate a base layer bitstream.

The IT/IQ unit 619 may perform inverse processing of T/Q to restore the video within the loop and generate a reconstructed video.

The calculation unit 621 may complete a reconstructed video (loop reconstruction) by combining the restoration data from the inter/intra prediction unit 611 and an inverse quantization/inverse transform unit 691. The reconstructed video may be used for subsequent filtering operations and the DPB 629 storage.

The DF unit 623 may remove block boundary discontinuities caused by block-based encoding and mitigate unnatural boundary differences between adjacent blocks

The SAO unit 625 may adjust the bias for each pixel value to correct quantization errors and reduce artifacts occurring at video boundaries.

The ALF unit 627 may perform adaptive filtering on decoded videos to improve visual quality and may be applied to the last operation of filters within the encoding loop.

The DPB 629 is a buffer that stores previous frames and may be used as a reference view for inter-prediction and inter-layer prediction during subsequent encoding.

The 3-1 encoder 610 may generate a residual signal by performing intra-screen or inter-screen prediction through the inter/intra prediction unit 611 and generate a base layer bitstream by transforming, quantizing, and entropy coding the residual signal. The 3-1 encoder 610 may perform an inverse transformation/inverse quantization process, then adds a prediction signal residual signal to generate a restored video, and apply a DF, a SAO, and an ALF to the restored video to store the restored video in the DPB. The videos stored in the DPB may be used for inter-screen prediction in the base layer and may also be used as input to the enhancement layer.

The 3-2 encoder 650 may re-sample the right view restored by the 3-1 encoder 610, perform intra-screen or inter-screen prediction of the re-sampled right view, then generate a residual signal from the left view, and encode the generated residual signal to generate an enhancement layer bitstream.

The 3-2 encoder 650 may include a re-sampling unit 652, an inter/intra prediction unit 651, a residual subtractor 653, a T/Q unit 655, an entropy coding unit 657, an IT/IQ unit 659, a calculation unit 661, a DF unit 663, a SAO unit 665, an ALF unit 667, and a DPB 669. The re-sampling unit 652 may re-sample the right view restored by the 3-1 encoder 610 and transform the re-sampled right view to have the same resolution as the high-resolution left view.

The inter/intra prediction unit 651 may perform intra-or inter-screen prediction of the re-sampled right view.

The residual subtractor 653 may generate a residual signal between the video within or between screens that is predicted through the inter/intra prediction unit 651 and the left view.

The residual subtractor 653 may calculate a difference between the downsampled low-resolution right view and the predicted video predicted by the inter/intra prediction unit 651 to calculate a prediction error (residual signal).

The T/Q unit 655 may perform frequency conversion (DCT or the like) and quantization processing on the residual signal calculated by the residual subtractor 653 to improve encoding efficiency.

The entropy coding unit 657 may compress the quantized residual signal using CABAC or the like to generate an enhancement layer bitstream. In this case, the generated enhancement layer bitstream may be used as input to the fourth encoder 700.

Since the IT/IQ unit 659, the calculation unit 661, the DF unit 663, the SAO unit 665, the ALF unit 667, and the DPB 669 perform the same operations as the IT/IQ unit 619, the calculation unit 621, the DF unit 623, the SAO unit 625, the ALF unit 627, and the DPB 629 of the 3-1 encoder 610, detailed descriptions thereof will be omitted.

The third encoder 600, configured as described above, may use a reference view and downsampled additional view as inputs for 3D multi-layer VVC. That is, the third encoder 600 may perform encoding on the additional view as the base layer and perform encoding on the reference view as the enhancement layer, but use the view restored through the base layer as the reference view.

The third encoder 600 may include a 3-1 encoder 610 and a 3-2 encoder 650 as illustrated in FIG. 6.

The 3-1 encoder 610 may encode the downsampled low-resolution right view using a preset encoding method to generate a base layer bitstream. In this case, the 3-1 encoder 610 may encode the downsampled low-resolution right view using multi-layer VVC.

Since the 3-1 encoder 610 performs the same operation as the 3-1 encoder 610 illustrated in FIG. 5, a detailed description thereof will be omitted.

The 3-2 encoder 650 may re-sample the right view restored by the 3-1 encoder 610, perform disparity refinement on the re-sampled right view on the basis of a depth map, perform intra-screen or inter-screen prediction between the disparity-refined right view and a previously stored left view, then generate a residual signal from the left view, and encode the generated residual signal to generate an enhancement layer bitstream.

The 3-2 encoder 650 may include a re-sampling unit 652, a view generation unit 654, an inter/intra prediction unit 651, a residual subtractor 653, a T/Q unit 655, an entropy coding unit 657, an IT/IQ unit 659, a calculation unit 661, a DF unit 663, a SAO unit 665, an ALF unit 667, and a DPB 669.

The re-sampling unit 652 may re-sample the right view restored by the 3-1 encoder 610. That is, the re-sampling unit 652 may re-sample the right view restored by the 3-1 encoder 610 to generate a right view having the same resolution as the original left view.

The view generation unit 654 may perform disparity refinement on the right view re-sampled by the re-sampling unit 652 using the depth map.

The view generation unit 654 may perform disparity refinement on the re-sampled right view on the basis of the depth map acquired by analyzing a correspondence relationship between the original left and right views. That is, the view generation unit 654 may search the depth map for a depth value corresponding to each pixel of the re-sampled right view, calculate a disparity of the pixel on the basis of the searched depth value, and perform disparity refinement on the re-sampled right view using the calculated disparity.

A detailed description of the view generation unit 654 will be described with reference to the view generation unit 315 illustrated in FIG. 3.

The inter/intra prediction unit 651 may perform intra-screen or inter-screen prediction of the right view disparity-refined by the view generation unit 654.

The residual subtractor 653 may generate a residual signal between the video within or between screens that is predicted through the inter/intra prediction unit 651 and the left view.

The T/Q unit 655 may perform frequency conversion (e.g., DCT) and quantization processing on the residual signal calculated by the residual subtractor 653 to improve encoding efficiency.

The entropy coding unit 657 may compress the quantized residual signal using CABAC or the like to generate an enhancement layer bitstream. In this case, the generated enhancement layer bitstream may be used as input to the fourth encoder 700.

Since the IT/IQ unit 659, the calculation unit 661, the DF unit 663, the SAO unit 665, the ALF unit 667, and the DPB 669 perform the same operations as the IT/IQ unit 619, the calculation unit 621, the DF unit 623, the SAO unit 625, the ALF unit 627, and the DPB 629 of the 3-1 encoder 610, detailed descriptions thereof will be omitted.

The third encoder 600, configured as described above, may generate a new viewpoint using the additional view that is restored based on a depth map within a 3D multi-layer VVC structure. The video with the new viewpoint may be used as a reference view during the encoding process of a 3D multi-layer VVC enhancement layer, and thus a reference view with improved video quality may be generated.

Referring to FIG. 4 again, the fourth encoder 700 may upscale the reference view restored by the third encoder 600, perform disparity refinement on the upscaled reference view, and encode a residual signal between the reference view and the disparity-refined reference view to generate an enhancement layer bitstream.

Since the fourth encoder 700 performs the same operation as the second encoder 300 illustrated in FIG. 3, a detailed description thereof will be omitted.

Meanwhile, in the present embodiment, although the components for generating the base layer bitstream and the enhancement layer bitstream are described as the third encoder 600 and the fourth encoder 700, the third encoder 600 may correspond to the first encoder 200 and the fourth encoder 700 may correspond to the second encoder 300.

The multiplexer 400 may multiplex the base layer bitstream generated by the third encoder 600 and the enhancement layer bitstream generated by the fourth encoder 700. That is, the multiplexer 400 may combine the base layer bitstream and the enhancement layer bitstream into a single transport stream. The multiplexed stream allows the receiving decoder to separate and decode each stream and finally reconstruct a high-quality s3D video.

The transmitter 500 may transmit the streams multiplexed by the multiplexer 400 to a reception apparatus.

The transmitter 500 may convert the base layer bitstream and the enhancement layer bitstream into at least one transport stream and transmit the at least one converted transport stream. Here, the transport stream may be called a PLP stream or a different term may be used as the transport stream according to the type of network through which the stream is transmitted. For example, when the base layer bitstream and the enhancement layer bitstream are each converted into different transport streams, the transport stream corresponding to the base layer bitstream may be transmitted through a mobile TV channel of a mobile network and the transport stream corresponding to the enhancement layer bitstream may be transmitted through a fixed TV channel of a broadcast network. Conversely, when the base layer bitstream and the enhancement layer bitstream are converted into a single transport stream, the transport stream may be transmitted through the same network.

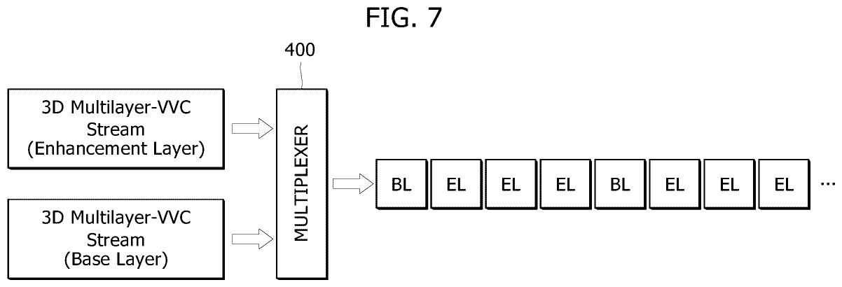

For example, FIG. 7 is an exemplary diagram illustrating an example of data transmission of the 3D broadcast transmission apparatus for providing a 3D broadcasting service according to the embodiment of the present invention. As illustrated in FIG. 7, the transmitter 500 may transmit data through a 5G mobile network or a broadband IP-based network (IPTV, OTT, etc.) on the basis of a control signal, according to a transmission environment. In this case, in order to improve transmission efficiency and reduce complexity of a reception terminal, the transmitter 500 may be configured to apply a single transmission packet structure (single stream packetization) in which a base layer bitstream BL and an enhancement layer bitstream EL are packetized within a single stream, or to enable transmission within a single PLP according to a physical layer structure of a broadcasting system. This configuration may allow for more efficient transmission of multi-layer video data while ensuring compatibility and flexibility in various network environments.

The transmitter 500 may modulate at least one converted transport stream using a predetermined modulation scheme and transmit the modulated transport stream. When the base layer bitstream and the enhancement layer bitstream are each converted into different transport streams, the transmitter 500 may modulate the respective transport streams using different modulation schemes. For example, the transport stream corresponding to the base layer bitstream may be modulated using a QPSK or 16-QAM method that has relatively good reception performance, and the transport stream corresponding to the enhancement layer bitstream may be modulated using a 256-QAM method that has high transmission efficiency.

The reception apparatus may demultiplex the RF signal to separately restore the base layer bitstream and the enhancement layer bitstream and finally output a high-resolution 3D video to a LCEVC decompressor. That is, the reception apparatus may decode the additional view on the basis of the base codec and then decode the reference view using the restored additional view and the enhancement layer.

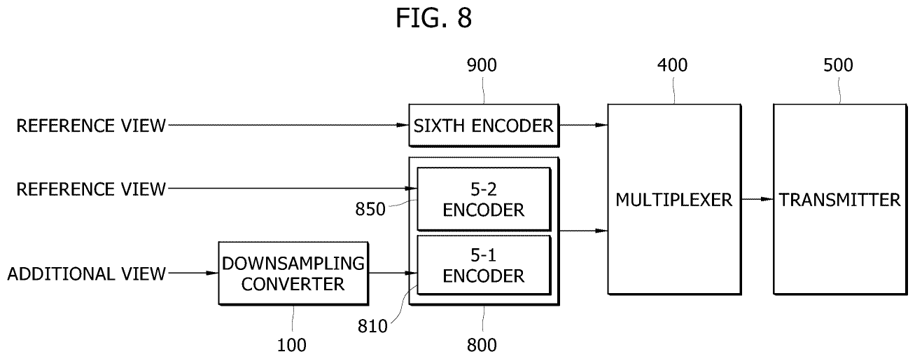

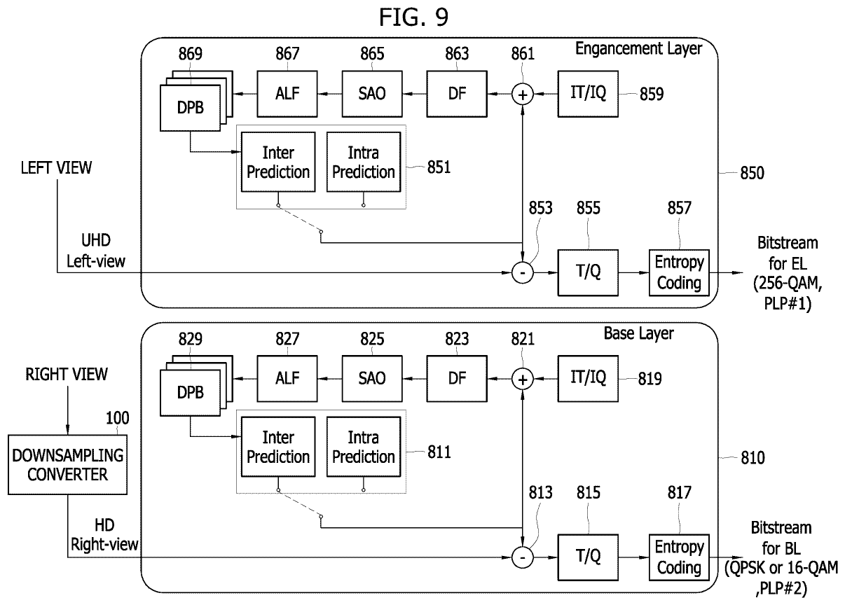

FIG. 8 is a block diagram illustrating a 3D broadcast transmission apparatus for providing a 3D broadcasting service according to still another embodiment of the present invention, and FIG. 9 is a diagram for describing a 5-1 encoder and 5-2 encoder described in FIG. 8.

Referring to FIG. 8, the 3D broadcast transmission apparatus for providing a 3D broadcasting service according to still another embodiment of the present invention may include a downsampling converter 100, a fifth encoder 800, a sixth encoder 900, a multiplexer 400, and a transmitter 500.

The downsampling converter 100 may downsample an additional view of a stereoscopic video into a low-resolution additional view.

The fifth encoder 800 may encode a left view and the low-resolution right view downsampled by the downsampling converter 100 using a preset encoding method. Here, the preset encoding method may be a s3D VVC method. That is, the fifth encoder 800 may encode the low-resolution right view downsampled by the downsampling converter 100 using a VVC method to generate a base layer bitstream and encode the left view using the VVC method to generate an enhancement layer bitstream. In this case, the enhancement layer bitstream may be a restored left view and may be used as a reference view for a ninth encoder.

The fifth encoder 800 may include a 5-1 encoder 810 and a 5-2 encoder 850.

The 5-1 encoder 810 may encode the downsampled low-resolution right view using a preset encoding method to generate a base layer bitstream. In this case, the 5-1 encoder 810 may encode the downsampled low-resolution right view using VVC.

The 5-1 encoder 810 may include an inter/intra prediction unit 811, a residual subtractor 813, a T/Q unit 815, an entropy coding unit 817, an IT/IQ unit 819, a calculation unit 821, a DF unit 823, a SAO unit 825, an ALF unit 827, and a DPB 829, as illustrated in FIG. 8.

Since the components of the 5-1 encoder 810 are the same as the components of the 3-1 encoder 610 illustrated in FIG. 5, detailed descriptions thereof will be omitted.

The 5-2 encoder 850 may encode the left view using a preset encoding method to generate an enhancement layer bitstream. In this case, the 5-2 encoder 850 may encode the left view using VVC.

Since the components of the 5-2 encoder 850 are the same as the components of the 5-1 encoder 810, detailed descriptions thereof will be omitted.

The sixth encoder 900 may upscale the reference view restored by the fifth encoder 800, perform disparity refinement on the upscaled additional view, and encode a residual signal between the reference view and the disparity-refined reference view to generate an enhancement layer bitstream.

Since the sixth encoder 900 performs the same operation as the second encoder 300 illustrated in FIG. 3, a detailed description thereof will be omitted.

Since the multiplexer 400 and the transmitter 500 perform the same operations as the multiplexer 400 and the transmitter 500 illustrated in FIG. 4, detailed descriptions thereof will be omitted.

Meanwhile, in the present embodiment, although the components for generating the base layer bitstream and the enhancement layer bitstream are described as the fifth encoder 800 and the sixth encoder 900, the fifth encoder 800 may correspond to the first encoder 200 and the sixth encoder 900 may correspond to the second encoder 300.

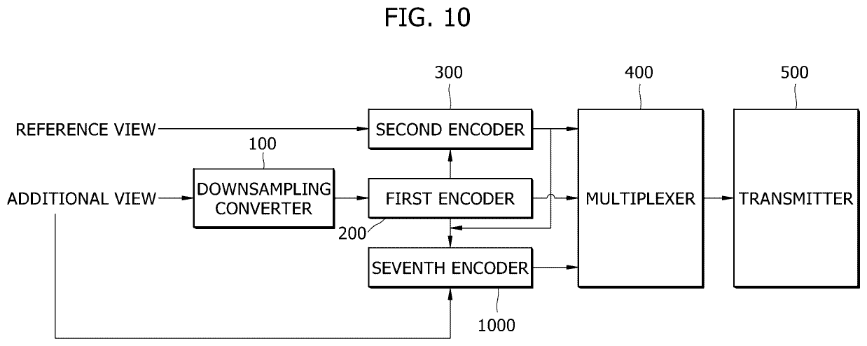

FIG. 10 is a block diagram illustrating a 3D broadcast transmission apparatus for providing a 3D broadcasting service according to still another embodiment of the present invention.

Referring to FIG. 10, the 3D broadcast transmission apparatus for providing a 3D broadcasting service may include a downsampling converter 100, a first encoder 200, a second encoder 300, a seventh encoder 1000, a multiplexer 400, and a transmitter 500.

Since the downsampling converter 100, the first encoder 200, and the second encoder 300 perform the same operations as the downsampling converter 100, the first encoder 200, and the second encoder 300 described above, detailed descriptions thereof will be omitted.

The seventh encoder 1000 may receive the additional view, the data from the second encoder 300, and the data from the first encoder 200 and generate additional information (video enhancement information (VEI)) for generating a high-resolution additional view with improved video quality.

For example, the seventh encoder 1000 may extract and interpolate (infer) inter-view correlation information (disparity, motion vector, etc.) between the corresponding views on the basis of the original additional view, the restored reference view, and the restored additional view to generate information for generating a high-resolution additional view.

For example, the seventh encoder 1000 may estimate a correlation (e.g., disparity and motion) between the left view and the right view based on learning or algorithm, generate the corresponding information as additional information, and, when restoring the video later, may interpolate or reconstruct high-resolution detailed information that is not present in the right view from the left view on the basis of the additional information.

In this way, the additional information generated by the seventh encoder 1000 may be used to generate a high-resolution additional view with improved video quality, and high-quality 3D content may be synthesized based on the generated high-resolution additional information. For example, during video decoding, a resolution additional view with improved video quality may be generated using the restored reference view, the restored additional view, and the additional information.

In this regard, in some embodiments of the present invention, additional information about the correlation between the left and right views (e.g., disparity and motion) may be generated in the original reference view and the downsampled additional view. Further, additional information may be generated to determine the correlation between the left and right views on the basis of various imaging operations during the encoding process, such as a correlation between the original reference view and the original additional view, a correlation between the upsampled additional view and the original reference view, etc.

The multiplexer 400 may be configured to multiplex the base layer bitstream generated by the first encoder 200, the enhancement layer bitstream generated by the second encoder 300, and the additional view with improved video quality generated by the seventh encoder 1000, into a single transmission channel, or to separate and transmit the bitstreams into multiple channels.

The transmitter 500 may transmit the streams multiplexed by the multiplexer 400 to the reception apparatus. In this case, the transmitter 500 may encapsulate the streams multiplexed by the multiplexer 400 in OFDM symbols and then transmit an RF signal through a transmission antenna.

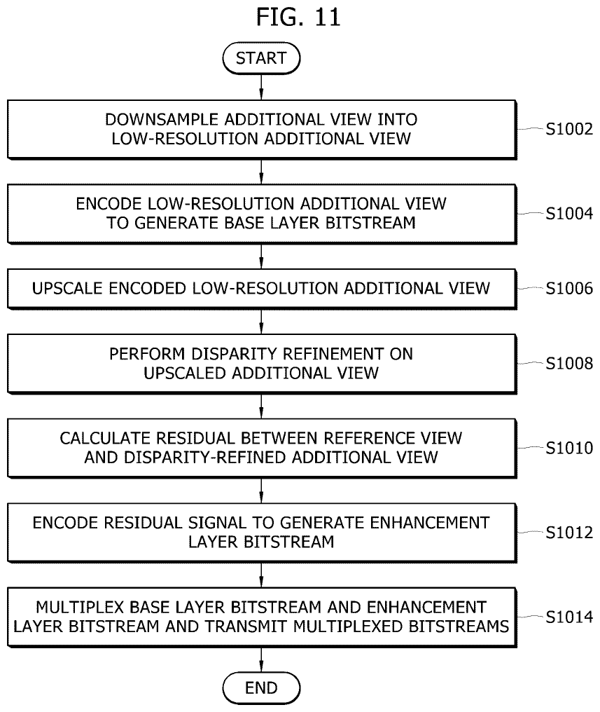

FIG. 11 is a flowchart for describing a 3D broadcast transmission method according to an embodiment of the present invention.

Referring to FIG. 11, a processor downsamples an additional view into a low-resolution additional view (S1002).

When operation S1002 is performed, the processor encodes the downsampled low-resolution additional view to generate a base layer bitstream (S1004). In this case, the processor may encode the low-resolution additional view using various encoding methods such as AVC, HEVC, VVC, etc.

When operation S1004 is performed, the processor upscales the encoded low-resolution additional view (S1006), and performs disparity refinement on the upscaled additional view (S1008). That is, the processor may upscale the low-resolution additional view to generate an additional view having the same resolution as an original reference view. Thereafter, the processor may perform disparity refinement on the upscaled additional view on the basis of a depth map acquired by analyzing a correspondence relationship between the original reference view and an original additional view.

When operation S1008 is performed, the processor calculates a residual between the reference view and the disparity-refined additional view (S1010). In this case, the processor may compare the reference view with the disparity-refined additional view pixel by pixel to calculate the residual between the two views.

When operation S1010 is performed, the processor encodes a residual signal to generate an enhancement layer bitstream (S1012). That is, the processor may perform temporal prediction, transform, quantization, and entropy encoding on the residual signal to generate an enhancement layer bitstream composed of an L-1 coefficient layer and a temporal layer.

When operation S1012 is performed, the processor multiplexes the base layer bitstream and the enhancement layer bitstream and transmits the multiplexed bitstreams (S1014).

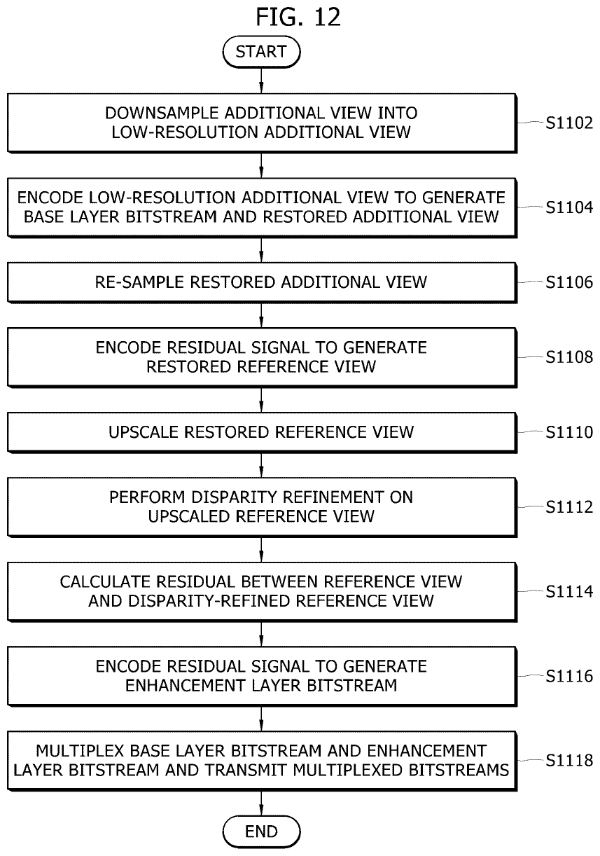

FIG. 12 is a flowchart for describing a 3D broadcast transmission method according to another embodiment of the present invention.

Referring to FIG. 12, the processor downsamples an additional view into a low-resolution additional view (S1102).

When operation S1102 is performed, the processor encodes the downsampled low-resolution additional view to generate a base layer bitstream and a restored additional view (S1104). In this case, the processor may perform encoding using a multi-layer VVC method.

When operation S1104 is performed, the processor re-samples the restored additional view (S1106), performs intra-screen or inter-screen prediction of the re-sampled additional view, then generates a residual signal with respect to the reference view, and encodes the generated residual signal to generate a restored reference view (S1108).

When operation S1108 is performed, the processor upscales the restored reference view (S1110) and performs disparity refinement on the upscaled reference view (S1112). That is, the processor may upscale the low-resolution reference view to generate a reference view having the same resolution as an original reference view. Thereafter, the processor may perform disparity refinement on the upscaled reference view on the basis of a depth map acquired by analyzing a correspondence relationship between the original reference view and an original additional view.

When operation S1112 is performed, the processor calculates a residual between the reference view and the disparity-refined reference view (S1114). In this case, the processor may compare the reference view with the disparity-refined reference view pixel by pixel to calculate the residual between the two views.

When operation S1114 is performed, the processor encodes a residual signal to generate an enhancement layer bitstream (S1116). That is, the processor may perform temporal prediction, transform, quantization, and entropy encoding on the residual signal to generate an enhancement layer bitstream composed of an L-1 coefficient layer and a temporal layer.

When operation S1114 is performed, the processor multiplexes the base layer bitstream and the enhancement layer bitstream and transmits the multiplexed bitstreams (S1116).

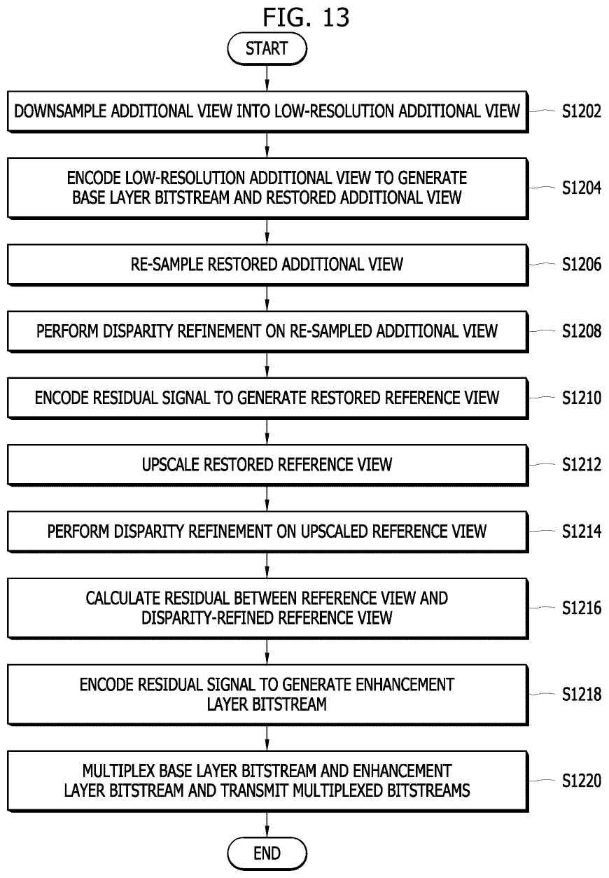

FIG. 13 is a flowchart for describing a 3D broadcast transmission method according to still another embodiment of the present invention.

Referring to FIG. 13, the processor downsamples an additional view into a low-resolution additional view (S1202).

When operation S1202 is performed, the processor encodes the downsampled low-resolution additional view to generate a base layer bitstream and a restored additional view (S1204). In this case, the processor may perform encoding using a multi-layer VVC method.

When operation S1204 is performed, the processor re-samples the restored additional view (S1206), performs disparity refinement on the re-sampled additional view on the basis of a depth map (S1208), performs intra-screen or inter-screen prediction of the disparity-refined additional view, then generates a residual signal with respect to the reference view, and encodes the generated residual signal to generate a restored reference view (S1210).

When operation S1210 is performed, the processor upscales the restored reference view (S1212) and performs disparity refinement on the upscaled reference view (S1214). That is, the processor may upscale the low-resolution reference view to generate a reference view having the same resolution as an original reference view. Thereafter, the processor may perform disparity refinement on the upscaled reference view on the basis of a depth map acquired by analyzing a correspondence relationship between the original reference view and an original additional view.

When operation S1214 is performed, the processor calculates a residual between the reference view and the disparity-refined reference view (S1216). In this case, the processor may compare the reference view with the disparity-refined reference view pixel by pixel to calculate the residual between the two views.

When operation S1216 is performed, the processor encodes a residual signal to generate an enhancement layer bitstream (S1218). That is, the processor may perform temporal prediction, transform, quantization, and entropy encoding on the residual signal to generate an enhancement layer bitstream composed of an L-1 coefficient layer and a temporal layer.

When operation S1218 is performed, the processor multiplexes the base layer bitstream and the enhancement layer bitstream and transmits the multiplexed bitstreams (S1220).

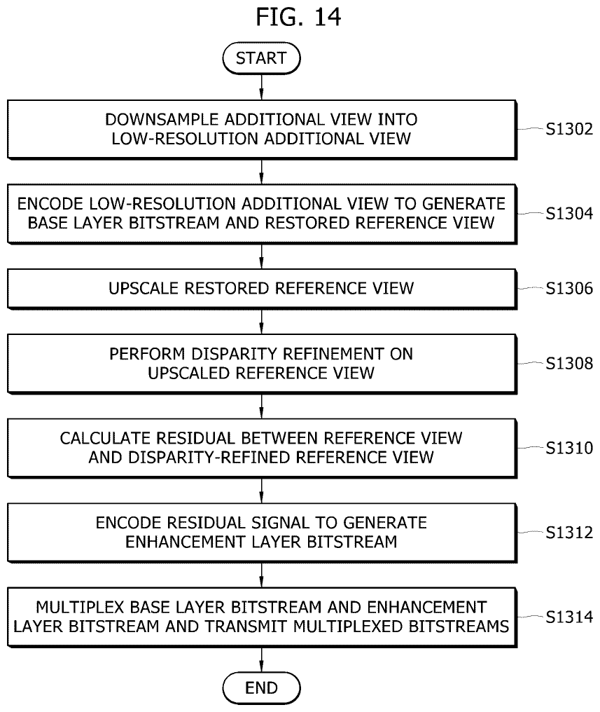

FIG. 14 is a flowchart for describing a 3D broadcast transmission method according to yet another embodiment of the present invention.

Referring to FIG. 14, the processor downsamples an additional view into a low-resolution additional view (S1302).

When operation S1302 is performed, the processor encodes the downsampled low-resolution additional view using a VVC method to generate a base layer bitstream and encodes a reference view using a VVC method to generate a restored reference view (S1304).

When operation S1304 is performed, the processor upscales the restored reference view (S1306) and performs disparity refinement on the upscaled reference view (S1308). That is, the processor may upscale the low-resolution reference view to generate a reference view having the same resolution as an original reference view. Thereafter, the processor may perform disparity refinement on the upscaled reference view on the basis of a depth map acquired by analyzing a correspondence relationship between the original reference view and an original additional view.

When operation S1308 is performed, the processor calculates a residual between the reference view and the disparity-refined reference view (S1310). In this case, the processor may compare the reference view with the disparity-refined reference view pixel by pixel to calculate the residual between the two views.

When operation S1310 is performed, the processor encodes a residual signal to generate an enhancement layer bitstream (S1312). That is, the processor may perform temporal prediction, transform, quantization, and entropy encoding on the residual signal to generate an enhancement layer bitstream composed of an L-1 coefficient layer and a temporal layer.

When operation S1312 is performed, the processor multiplexes the base layer bitstream and the enhancement layer bitstream and transmits the multiplexed bitstreams (S1314).

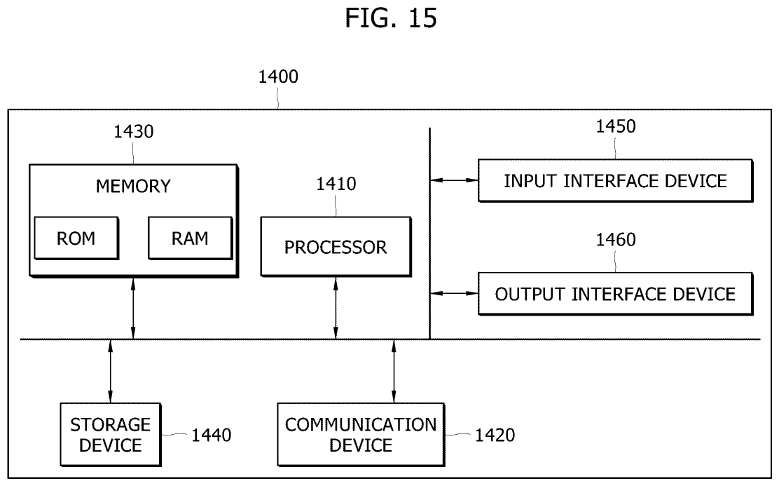

FIG. 15 is a block diagram illustrating an apparatus according to an embodiment of the present invention.

The apparatus according to an embodiment of the present invention may include a video encoding apparatus and a 3D broadcast transmission apparatus, and may be implemented as a computer system, for example, a computer-readable medium.

Referring to FIG. 15, the apparatus according to the embodiment of the present invention may include at least one of a processor 1410, a memory 1430, an input interface device 1450, an output interface device 1460, and a storage device 1440 that communicate via a bus 1470. A computer system 1400 may further include a communication device 1420 coupled to a network.

The processor 1410 may be configured to control the overall operation of the apparatus 1400. For example, the processor 1410 may execute software (e.g., a program) stored in the memory 1430 to control a component (e.g., at least one of the memory 1430, the input interface device 1450, the output interface device 1460, and the storage device 1440) connected to the processor 1410. The processor 1410 may execute software (e.g., a program) for the operations of the downsampling converter 100, the first encoder 200, the second encoder 300, and the multiplexer 400. The processor 1410 may be a CPU, or a semiconductor device that executes instructions stored in the memory 1430 or storage device 1440. The memory 1430 and the storage device 1440 may include various types of volatile or non-volatile storage media. For example, the memory 1430 may include a read-only memory (ROM) and a random access memory (RAM). In the embodiment of the present invention, the memory 1430 may be located inside or outside the processor 1410 and connected to the processor 1410 via various known devices. The memory 1430 may include various types of volatile or non-volatile storage media, and the memory 1430 may include, for example, a ROM or a RAM.

Therefore, the embodiment of the present invention may be implemented as a method implemented on a computer or with a non-transitory computer-readable medium in which computer-executable instructions are stored. In one embodiment, when executed by the processor, computer-readable instructions may perform a method according to at least one aspect of the present invention.

The communication device 1420 may transmit or receive wired signals or wireless signals.

Meanwhile, in the video encoding apparatus, the 3D broadcast transmission apparatus including the same, and the 3D broadcast transmission method according to some embodiments of the present invention, disparity refinement on an additional view can be perform by utilizing binocular disparity information, a residual signal between an original reference view and the additional view can be reduced based on the disparity-refined additional view, and thus the encoding performance of 3D LCEVC can be improved, thereby providing higher quality s3D stereoscopic media content.

In the video encoding apparatus, the 3D broadcast transmission apparatus including the same, and the 3D broadcast transmission method according to some embodiments of the present invention, by improving the encoding performance of 3D LCEVC, high-quality streaming services and real-time broadcasting services can be provided.

In the video encoding apparatus, the 3D broadcast transmission apparatus including the same, and the 3D broadcast transmission method according to some embodiments of the present invention, in the case in which encoding is performed using multi-layer VVC, disparity refinement on the reference view can be performed to generate an improved reference view, thereby improving the encoding performance of inter-screen prediction, and the generated improved reference view can be used as input to LCEVC, and thus a reference view with further improved video quality can be generated.

In the video encoding apparatus, the 3D broadcast transmission apparatus including, and the 3D broadcast transmission method the same according to some embodiments of the present invention, high-resolution additional view with improved picture quality can be generated by combining VEI with 3D LCEVC, and thus high-quality 3D content can be synthesized based on the generated high-resolution additional view.

While the present invention has been described with reference to embodiments illustrated in the accompanying drawings, the embodiments should be considered in a descriptive sense only, and it should be understood by those skilled in the art that various alterations and other equivalent embodiments may be made. Therefore, the scope of the present invention should be defined by only the following claims.

### LIST OF DEFINITIONS OF REFERENCE NUMERALS

100: A downsampling converter
200: A first encoder
300: A second encoder
400: A multiplexer
500: A transmitter
600: A third encoder
700: A fourth encoder
800: A fifth encoder
900: A sixth encoder
1000: A seventh encoder

What is claimed is:

1. A video encoding apparatus comprising:
a memory configured to store a program for encoding a three-dimensional (3D) video; and
a processor configured to execute the program stored in the memory,
wherein the processor encodes a downsampled low-resolution additional view to generate a base layer bitstream, upscales the encoded low-resolution additional view, and secondarily encodes a residual signal between a reference view and the upscaled additional view to generate an enhancement layer bitstream.

2. The video encoding apparatus of claim 1, wherein the processor includes:
a downsampling converter that downsamples the additional view into a low-resolution additional view;
a first encoder that encodes the downsampled low-resolution additional view according to a preset encoding method to generate the base layer bitstream; and
a second encoder that upscales the low-resolution additional view encoded by the first encoder and encodes the residual signal between the reference view and the upscaled additional view to generate the enhancement layer bitstream.

3. The video encoding apparatus of claim 2, wherein the second encoder encodes the residual signal using a Low Complexity Enhancement Video Codec (LCEVC) method.

4. The video encoding apparatus of claim 2, wherein the first encoder encodes the low-resolution additional view using at least one of Advanced Video Coding (AVC), High Efficiency Video Coding (HEVC), and Versatile Video Coding (VVC) methods.

5. The video encoding apparatus of claim 2, wherein the first encoder performs encoding using a multi-layer VVC method, and
the first encoder encodes the downsampled low-resolution additional view to generate the base layer bitstream and a restored additional view, re-samples the restored additional view, performs intra-screen or inter-screen prediction of the re-sampled additional view, then generates the residual signal with respect to the reference view, encodes the residual signal to generate the restored reference view, and inputs the restored reference view to the second encoder.

6. The video encoding apparatus of claim 2, wherein the first encoder performs encoding using a multi-layer VVC method, and
the first encoder encodes the downsampled low-resolution additional view to generate the base layer bitstream and a restored additional view, re-samples the restored additional view, performs disparity refinement on the re-sampled additional view on the basis of a depth map, performs intra-screen or inter-screen prediction of the disparity-refined additional view, then generates the residual signal with respect to the reference view, encodes the residual signal to generate the restored reference view, and inputs the restored reference view to the second encoder.

7. The video encoding apparatus of claim 6, wherein the second encoder upscales the restored reference view, performs disparity refinement on the upscaled reference view on the basis of the depth map, and encodes the residual signal between the reference view and the disparity-refined additional view to generate the enhancement layer bitstream.

8. The video encoding apparatus of claim 2, wherein the first encoder performs encoding using a stereoscopic 3D VVC method, and
the first encoder encodes the downsampled low-resolution additional view using a VVC method to generate the base layer bitstream, encodes the reference view using a VVC method to generate the restored reference view, and inputs the restored reference view to the second encoder.

9. The video encoding apparatus of claim 8, wherein the second encoder upscales the restored reference view, performs disparity refinement on the upscaled reference view on the basis of the depth map, and encodes the residual signal between the reference view and the disparity-refined additional view to generate the enhancement layer bitstream.

10. The video encoding apparatus of claim 2, further comprising a video enhancement information (VEI) encoder configured to receive at least one of the additional view, the reference view restored by the second encoder, and the additional view restored by the first encoder and generate additional information for generating a high-resolution additional view with improved video quality.

11. The video encoding apparatus of claim 1, wherein the processor receives the reference view and the low-resolution additional view and generates additional information for generating a high-resolution additional view with improved video quality.

12. A three-dimensional (3D) broadcast transmission apparatus that encodes a reference view and an additional view that constitute a 3D video to provide a service, the 3D broadcast transmission apparatus comprising:
a first encoder configured to encode a downsampled low-resolution additional view to generate a base layer bitstream;
a second encoder configured to upscale the low-resolution additional view encoded by the first encoder and encode a residual signal between the reference view and the upscaled additional view to generate an enhancement layer bitstream;
a multiplexer configured to multiplex the base layer bitstream and the enhancement layer bitstream; and
a transmitter configured to transmit the multiplexed streams to a reception apparatus.

13. The 3D broadcast transmission apparatus of claim 12, wherein the first encoder performs encoding using at least one of Advanced Video Coding (AVC), High Efficiency Video Coding (HEVC), Versatile Video Coding (VVC), multi-layer VVC, and stereoscopic 3D VVC methods.

14. The 3D broadcast transmission apparatus of claim 13, wherein, when the first encoder performs encoding using the multi-layer VVC method, the first encoder encodes the downsampled low-resolution additional view to generate the base layer bitstream and a restored additional view, re-samples the restored additional view, performs disparity refinement on the re-sampled additional view on the basis of a depth map, performs intra-screen or inter-screen prediction of the disparity-refined additional view, then generates the residual signal with respect to the reference view, encodes the residual signal to generate the restored reference view, and inputs the restored reference view to the second encoder.

15. The 3D broadcast transmission apparatus of claim 13, wherein, when the first encoder performs encoding using the stereoscopic 3D VVC method, the first encoder encodes the downsampled low-resolution additional view using a VVC method to generate the base layer bitstream, encodes the reference view using a VVC method to generate the restored reference view, and inputs the restored reference view to the second encoder.

16. The 3D broadcast transmission apparatus of claim 12, wherein the second encoder performs disparity refinement on the upscaled additional view using a pre-stored depth map.

17. A three-dimensional (3D) broadcast transmission method comprising:
encoding, by a processor, a downsampled low-resolution additional view and generating a base layer bitstream;
upscaling, by the processor, the encoded low-resolution additional view, encoding a residual signal between a reference view and the upscaled additional view, and generating an enhancement layer bitstream; and
transmitting, by the processor, the base layer bitstream and the enhancement layer bitstream.

18. The 3D broadcast transmission method of claim 17, wherein, in the generating of the base layer bitstream, the processor performs encoding using at least one of Advanced Video Coding (AVC), High Efficiency Video Coding (HEVC), and Versatile Video Coding (VVC) methods.

19. The 3D broadcast transmission method of claim 17, wherein, in the generating of the enhancement layer bitstream, the processor performs disparity refinement on the upscaled additional view using a pre-stored depth map.

20. The 3D broadcast transmission method of claim 17, further comprising receiving, by the processor, the reference view and the low-resolution additional view and generating additional information for generating a high-resolution additional view with improved video quality.
